(19) United States
(12) Patent Application Publication
(10) Pub. No.: US 2023/0354853 A1
(43) Pub. Date: Nov. 9, 2023

(54) ANIMAL FEED SUPPLEMENT AND METHODS OF MAKING

(71) Applicants: JACOB JOHN ALBRECHT, Eden Prairie, MN (US); MILK SPECIALTIES COMPANY DBA MILK SPECIALTIES GLOBAL, Eden Prairie, MN (US)

(72) Inventor: Jacob John ALBRECHT, Chaska, MN (US)

(21) Appl. No.: 18/017,464

(22) PCT Filed: Jul. 23, 2021
(86) PCT No.: PCT/US2021/042934

§ 371 Date: Jan. 23, 2023

Related U.S. Application Data
(60) Provisional application No. 63/055,397, filed on Jul. 23, 2020.

(51) Int. Cl. A23K 50/10; A23K 20/142; A23K 20/158

(52) U.S. Cl. CPC A23K 50/10; A23K 20/142; A23K 20/158

(57) ABSTRACT

A solid animal feed composition generally includes a liquid nutrient component in an amount of 1% to 40% by weight and a fatty acid component in an amount of 60% to 99% by weight. The solid animal feed composition has a melting point of at least 70° F. The animal feed composition can be fed to lactating dairy cows to increase milk production, increase the fat content of milk produced by the cow, and/or increase the protein content of milk produced by the cow.

### CROSS-REFERENCE TO RELATED APPLICATION

This application claims the benefit of U.S. Provisional Patent Application No. 63/055,397, filed Jul. 23, 2020, which is incorporated herein by reference in its entirety.

### SUMMARY

This disclosure describes, in one aspect, a solid animal feed composition. Generally, the solid animal feed composition includes a liquid nutrient component in an amount of 1% to 40% by weight and a fatty acid component in an amount of 60% to 99% by weight. The solid animal feed composition has a melting point of at least 70° F.

In some embodiments, the liquid nutrient component is present in an amount of from 1% to 25%. In some embodiments, the liquid nutrient can include a liquid analog of a solid nutrient. In some of these embodiments, the liquid nutrient can include a liquid analog of methionine.

In some embodiments, the solid animal feed composition can further include tallow, lard, corn oil, soy oil, coconut oil, palm oil, palm stearin, a hydrogenated fat, a non-hydrogenated fat, an emulsifier, a fat-soluble vitamin, an organic acid, a cation, or any combination of two or more of the foregoing.

In some embodiments, the animal feed composition has a Shore A hardness of at least 50.

In some embodiments, the animal feed composition has a melting point of at least 120° F.

In another aspect, this disclosure describes a method of making a solid animal feed supplement from liquid materials. Generally, the method includes melting a fatty acid composition, adding a liquid nutrient to form an intermediate mixture, and cooling the intermediate mixture in a manner effective to produce a solid animal feed supplement.

In some embodiments, cooling the intermediate mixture includes introducing the intermediate into a prilling tower.

In some embodiments, the intermediate mixture has a fatty acid:liquid nutrient ratio of from 99:1 to 75:25, by weight.

In some embodiments, the liquid nutrient includes an analog of methionine.

In some embodiments, the intermediate mixture further includes tallow, lard, coconut oil, corn oil, soy oil, palm oil, palm stearin, a hydrogenated fat, a non-hydrogenated fat, an emulsifier, a fat-soluble vitamin, an organic acid, a cation, or any combination of two or more of the foregoing.

In another aspect, this disclosure describes a method of increasing milk production in a lactating cow. Generally, the method includes feeding a nutritional supplement that includes any embodiment of the animal feed composition summarized above to the lactating cow in an amount effective to increase milk production by the cow.

In another aspect, this disclosure describes a method of increasing milk fat content in milk. Generally, the method includes feeding a nutritional supplement that includes any embodiment of the animal feed composition summarized above to a lactating cow producing milk with low fat content in an amount effective to increase the fat content of the milk produced by the cow.

In another aspect, this disclosure describes a method of increasing protein content in milk produced by a lactating cow. Generally, the method includes feeding a nutritional supplement that includes any embodiment of the animal feed composition summarized above to a lactating cow producing milk with low protein content in an amount effective to increase the protein content of the milk produced by the cow.

The above summary is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1. Unprilled combinations of fatty acid (a mixture of palmitic acid, stearic acid, and oleic acid) and liquid methionine analog 2-hydroxy-4-(methylthio) butanoate (HMTBa, ALIMET, Novus International, St. Charles, MO). (A) At 190° F., the fatty and HMTBa are both liquid and remain phase separated: fatty acid (80 wt %) in the top phase, HMTBa (20 wt %) in the bottom phase. (B) At 80° F., the fatty acid is solid and the HMTBa is liquid and remain separated: fatty acid (80%, top), HMTBa (20%, bottom).

FIG. 2. HMTBa added to a fatty acid nutritional supplement (ENERGY BOOSTER 100, Milk Specialties Global, Inc., Eden Prairie, MN) increase milk fat content in milk from lactating cows producing milk with low fat content.

FIG. 3. Removing HMTBa from feed (ENERGY BOOSTER MERGE, Milk Specialties, Global, Inc., Eden Prairie, MN) reduced milk protein content in milk produced by lactating cows.

FIG. 4. Adding HMTBa to a fatty acid nutritional supplement (ENERGY BOOSTER 100, Milk Specialties Global, Inc., Eden Prairie, MN) increases milk production in lactating dairy cows. The dotted line indicates a change in nutritional supplementation. (A) Trial 1: Milk production increased by 3.0 lbs. per cow without reducing milk fat content or milk protein content. (B) Trial 2: Milk production increased by 3.3 lbs. per cow without reducing milk fat content or milk protein content.

FIG. 5. Characterization of prilled animal feed compositions. (A) Fatty acid nutritional supplement (ENERGY BOOSTER 100, Milk Specialties Global, Inc., Eden Prairie, MN). The prilled product is dry to the touch and has an angle of repose of 38°. (B) Mixture of 90% hot liquid fatty acid nutritional supplement (ENERGY BOOSTER 100, Milk Specialties Global, Inc., Eden Prairie, MN) and hot 10% HMTBa is prilled. The product is dry to the touch and has an angle of repose of 38°. (C) Mixture of prilled 90% fatty acid nutritional supplement (ENERGY BOOSTER 100, Milk Specialties Global, Inc., Eden Prairie, MN) and 10% HMTBa. The product is moist to the touch and has an angle of repose of 80°.

FIG. 6. Characterization of prilled animal feed compositions. (A) Mixture of 95% fatty acid nutritional supplement (ENERGY BOOSTER 100, Milk Specialties Global, Inc., Eden Prairie, MN) and 5% butyric acid (Eastman Chemical Co., Kingsport, TN). The product is moist to the touch and has an angle of repose of 62° (left panel). Mixture of 95% hot liquid fatty acid nutritional supplement (ENERGY BOOSTER 100, Milk Specialties Global, Inc., Eden Prairie, MN) and hot 5% butyric acid is prilled. The product is dry to the touch and has an angle of repose of 30° (right panel). (B) Mixture of 95% fatty acid nutritional supplement (ENERGY BOOSTER 100, Milk Specialties Global, Inc., Eden Prairie, MN) and 5% isobutyric acid. The product is moist to the touch and has an angle of repose of 64° (left panel). Mixture of 95% hot liquid fatty acid nutritional supplement (ENERGY BOOSTER 100, Milk Specialties Global, Inc., Eden Prairie, MN) and hot 5% isobutyric acid is prilled. The product is dry to the touch and has an angle of repose of 27° (right panel).

FIG. 7. Characterization of prilled animal feed compositions. (A) Mixture of 95% fatty acid nutritional supplement (ENERGY BOOSTER 100, Milk Specialties Global, Inc., Eden Prairie, MN) and 5% lecithin (Solae, LLC, St. Louis, MO). The product is moist to the touch and has an angle of repose of 36° (left panel). Mixture of 95% hot liquid fatty acid nutritional supplement (ENERGY BOOSTER 100, Milk Specialties Global, Inc., Eden Prairie, MN) and hot 5% lecithin is prilled. The product is dry to the touch and has an angle of repose of 29° (right panel). (B) Mixture of 95% fatty acid nutritional supplement (ENERGY BOOSTER 100, Milk Specialties Global, Inc., Eden Prairie, MN) and 5% lysolecithin K (Kemin Industries, Inc., Des Moines, IA). The product is moist to the touch and has an angle of repose of 62° (left panel). Mixture of 95% hot liquid fatty acid nutritional supplement (ENERGY BOOSTER 100, Milk Specialties Global, Inc., Eden Prairie, MN) and hot 5% lysolecithin K is prilled. The product is dry to the touch and has an angle of repose of 23° (right panel). (C) Mixture of 95% fatty acid nutritional supplement (ENERGY BOOSTER 100, Milk Specialties Global, Inc., Eden Prairie, MN) and 5% lysolecithin TA (Thew Arnott & Co. Ltd., Deeside, UK). The product is moist to the touch and has an angle of repose of 37° (left panel). Mixture of 95% hot liquid fatty acid nutritional supplement (ENERGY BOOSTER 100, Milk Specialties Global, Inc., Eden Prairie, MN) and hot 5% lysolecithin TA is prilled. The product is dry to the touch and has an angle of repose of 25° (right panel).

FIG. 8. Characterization of prilled animal feed compositions. (A) Mixture of 92.7% fatty acid nutritional supplement (ENERGY BOOSTER 100, Milk Specialties Global, Inc., Eden Prairie, MN) and 7.3% HMTBa. The product is moist to the touch and has an angle of repose of 51° (left panel). Mixture of 92.7% hot liquid fatty acid nutritional supplement (ENERGY BOOSTER 100, Milk Specialties Global, Inc., Eden Prairie, MN) and hot 7.3% HMTBa is prilled. The product is dry to the touch and has an angle of repose of 22° (right panel). (B) Mixture of 90% fatty acid nutritional supplement (ENERGY BOOSTER 100, Milk Specialties Global, Inc., Eden Prairie, MN) and 10% propylene glycol (Aspen Veterinary Resources Ltd., Liberty, MO). The product is moist to the touch and has an angle of repose of 41° (left panel). Mixture of 90% hot liquid fatty acid nutritional supplement (ENERGY BOOSTER 100, Milk Specialties Global, Inc., Eden Prairie, MN) and hot 10% propylene glycol is prilled. The product is dry to the touch and has an angle of repose of 26° (right panel).

FIG. 9. Melt point of fatty acid nutritional supplement (ENERGY BOOSTER 100, Milk Specialties Global, Inc., Eden Prairie, MN) supplemented with either HMTBa or a fatty acid composition of approximately 80% oleic acid (IV; iodine value).

FIG. 10. Shore A hardness of fatty acid nutritional supplement (ENERGY BOOSTER 100, Milk Specialties Global, Inc., Eden Prairie, MN) supplemented with either HMTBa or a fatty acid composition of approximately 80% oleic acid (IV; iodine value).

### DETAILED DESCRIPTION OF ILLUSTRATIVE EMBODIMENTS

This disclosure describes dry, solid animal feed compositions prepared from fat compositions and a liquid nutrient such as, for example, the liquid methionine analog 2-hydroxy-4-(methylthio) butanoate (HMTBa). As used herein, the term “liquid nutrient” refers to the state of the nutrients at room temperature (70° F.). Since the animal feed composition is a solid, the term “liquid nutrient” should not be construed as requiring that the liquid nutrient component of the animal feed composition is in a liquid state in the solid animal feed composition.

Prilled fats and the liquid methionine analog 2-hydroxy-4-(methylthio) butanoate (HMTBa) are frequently fed at the same time to dairy cows to improve milk fat yield in high producing early lactation dairy cows. Prilled fats are typically hard and dry. Thus, prilled fats are easy to handle either at the feed mill or on-farm. In contrast, HMTBa is typically only used in feeds when it can be sourced from feed mills. HMTBA is a liquid and therefore requires a tank for storage and equipment for handling. HMTBa also has a low pH (˜1.00) and is therefore a skin irritant, eye irritant, and respiratory irritant. Thus, HMTBa is typically not handled on-farm, but only at feed mills.

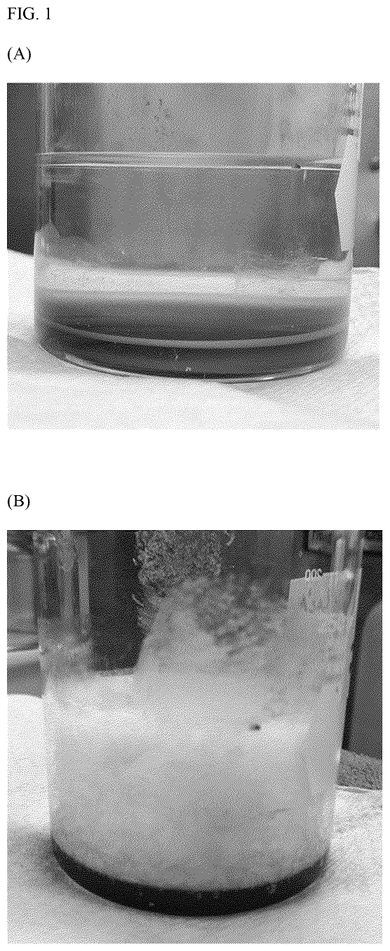

FIG. 1 provides photographs showing that fatty acids and the liquid methionine analog 2-hydroxy-4-(methylthio) butanoate (HMTBa) do not naturally mix. FIG. 1A shows that a combination of 80% fatty acids and 20% HMTBa heated to 190° F. do not mix. The fatty acid and the HMTBa remain in separate liquid phases. At 80° F., the fatty acid and the HMTBa remain separated (FIG. 1B).

Fatty acid and the liquid nutrient can, however, be combined as a liquid and then prilled to produce a solid animal feed product that is safe and easy to handle on-farm. The fat component of the composition can include any suitable nutritional fat, or a combination of nutritional fats, so that the fat component of the composition has a melting point high enough so that it remains solid at typical handling temperatures. In some embodiments, the fat component of the composition can have a melting point of at least 70° F., at least 75° F., at least 80° F., at least 85° F., at least 90° F., at least 95° F., at least 100° F., at least 105° F., at least 110° F., at least 115° F., at least 120° F., at least 125° F., at least 130° F., at least 135° F., at least 140° F., at least 145° F., at least 150° F., at least 155° F., at least 160° F., at least 165° F., or at least 170° F.

Exemplary suitable fats include mostly saturated free fatty acids including, but not limited to, caprylic acid, lauric acid, myristic acid, palmitic acid, stearic acid, oleic acid, linoleic acid, linolenic acid, arachidic acid, eicosapentaenoic acid, docosahexaenoic acid, and blends of any of the foregoing.

The liquid nutrient can be any suitable liquid nutrient that, when combined with the fat component and prilled, results in a solid product at room temperature (70° F.). Exemplary suitable liquid nutrients include, but are not limited to, 2-hydroxy-4-(methylthio) butanoate (HMTBa; ALIMET, Novus International, St. Charles, MO) or esters of HMTBa. Exemplary esters of HMTBa include, but are not limited to, 1-methylethyl HMTBa (METASMART, Adisseo USA Inc., Alpharetta, GA) or 2-propyl HMTBa (SEQUENT, Novus International, St. Charles, MO). Other suitable liquid nutrients include, but are not limited to, butyric acid, isobutyric acid, lecithin, lysolecithin (e.g., lysolecithin K or lysolecithin TA), or propylene glycol.

The fats used in the fat component are heated to form a liquid, then mixed with the liquid nutrient. The fat component and liquid nutrient can be mixed using any suitable method including, but not limited to, agitation, tank recirculation, or a combination of both.

The liquid mixture is then prilled, e.g., by being pumped into a chilled prilling tower. In one exemplary embodiment, the heated fat-liquid nutrient mixture is sprayed downwards at 90-100 psi and at 140° F. The prilling tower can be a closed loop system in which chilled recirculating air (40° F.) is blown upwards towards the nozzle through which the heated liquid mixture is sprayed into the prilling tower, is collected, and re-routed through a cooling coil and back to the bottom of the prilling tower. The hot liquid being exposed to chilled air makes the droplets solidify and prill. The solid prills are collected from the prilling tower and are either conveyed to packaging or stored for later distribution.

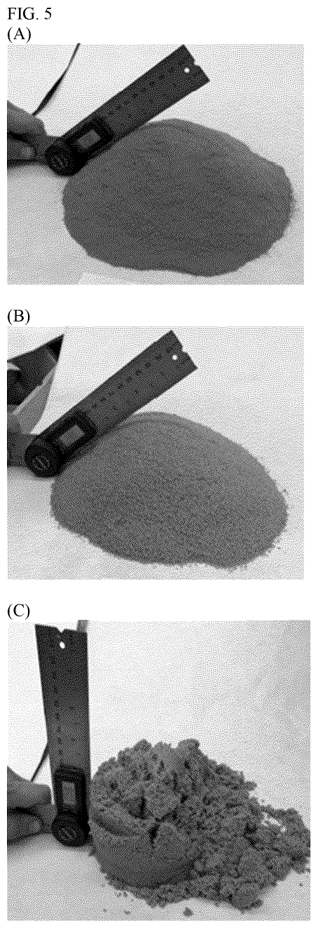

The process described herein produces a solid animal feed composition that is safe and easy to handle. FIG. 5A shows a prilled fatty acid nutritional supplement. The prilled nutritional supplement is solid, dry, and has an angle of repose of 38°. FIG. 5C shows a combination of a liquid nutrient (HMTBa) with a prilled fatty acid nutritional supplement. The resulting product is solid but is moist to the touch and has an angle of repose of 80°. Thus, mixing a dry, prilled fatty acid nutritional supplement with a liquid nutrient results in a product that is moist and more difficult to handle than the dry, prilled fatty acid supplement alone. In contrast to the mixture shown in FIG. 5C, FIG. 5B shows a dry, solid animal feed composition as described herein. The product is dry to the touch and has an angle of repose of 38°. The product is prepared as described above: the fatty acid nutritional supplement and the liquid nutrient are mixed while liquid, then co-prilled. The handling characteristics—as indicated by the angle of repose—are similar to those of the dry, solid, prilled fatty acid nutritional supplement alone (shown in FIG. 5A) despite being prepared using a liquid nutrient.

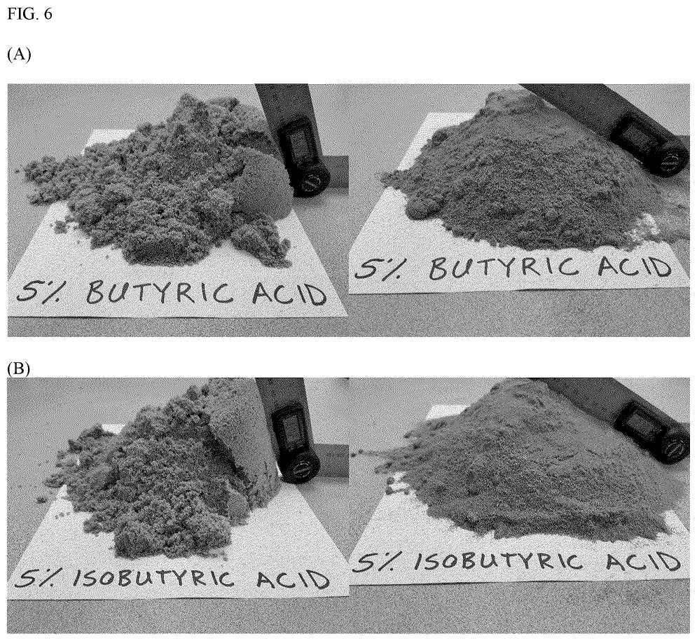

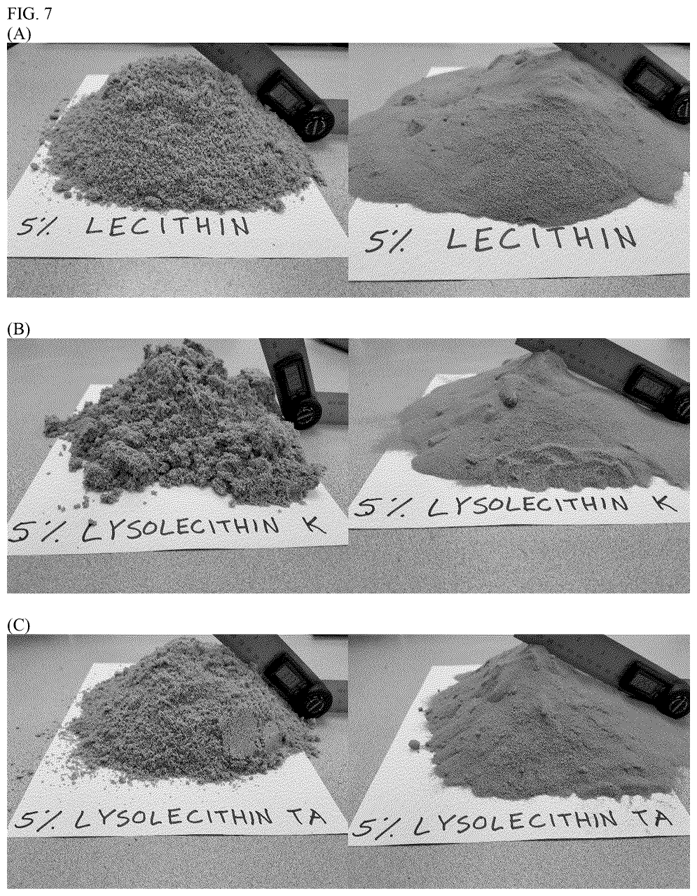

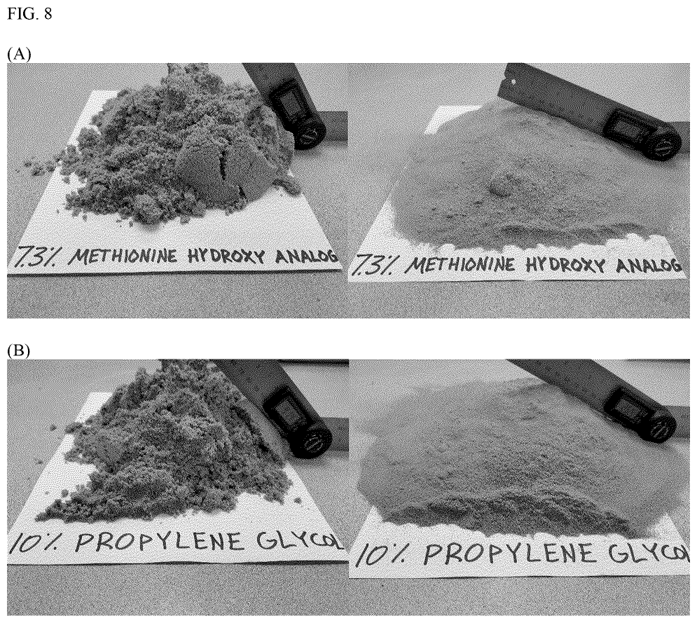

The character of the solid animal feed supplement prepared from a liquid nutrient is similar when alternative liquid nutrients are used. FIGS. 6-8 and Table 1 show similar comparisons of products prepared by co-prilling the fatty acid nutritional supplement and the liquid nutrient (right panels) compared to a mere mixture of the prilled fatty acid nutritional supplement with the liquid nutrient (left panels). In all cases, the animal feed supplement prepared by co-prilling the fatty acid nutritional supplement with the liquid nutrient has a lower angle of repose compared to a product prepared using the same components but with the liquid nutrient merely mixed with the fatty acid nutritional supplement. A lower angle of repose indicates the product flows better in a feed system.

TABLE 1
Angle of repose of animal feed compositions

| Liquid Nutrient | Mixed* | Co-Prilled\hat{ } | Difference |
|---|---|---|---|
| Butyric Acid 5% | 61.9 | 29.7 | 32.2 |
| Isobutyric Acid 5% | 64.2 | 27.0 | 37.2 |
| Lecithin 5% | 36.1 | 29.2 | 6.9 |
| Lysolecithin (K) 5% | 61.7 | 23.3 | 38.4 |
| Lysolecithin (TA) 5% | 37.3 | 25.5 | 11.8 |
| Methionine Hydroxy Analog 7.3% | 50.6 | 22.4 | 28.2 |
| Propylene Glycol 10% | 41.4 | 26.4 | 15.0 |

*Liquid nutrient mixed with prilled fatty acid nutrition supplement
\hat{ }Liquid nutrient mixed with fatty acid nutritional supplement, then co-prilled

In some embodiments, the composition can further include one or more additional ingredients. Optional ingredient include, but are not limited to, tallow, lard, coconut oil, palm oil, corn oil, soy oil, palm stearin, a hydrogenated fat, a non-hydrogenated fat, an emulsifier (e.g., lecithin, lysolecithin, tweens, etc.), a fat soluble vitamin (e.g., vitamin A, vitamin D, Vitamin E, etc.), an organic acid (e.g., fumaric acid or malic acid), a cation (e.g., a divalent cation such as Ca⁺⁺ or Mg⁺⁺), or any combination of two or more of the foregoing.

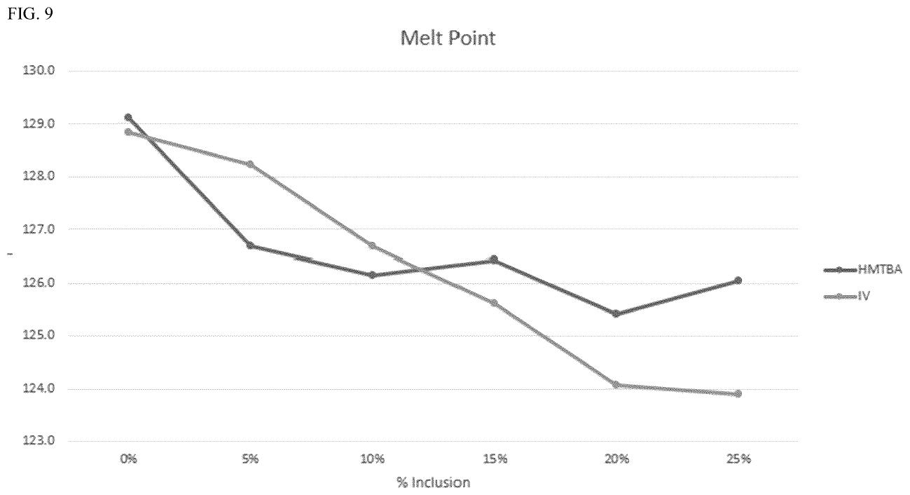

The process described herein allows one to produce a product that is solid at room temperature despite adding up to about 40% liquid to a saturated fatty acid component. FIG. 9 shows the effect that increasing the HMTBa content has on the melt point of the composition compared to a corresponding increase in the content of a fatty acid additive (e.g., 80% oleic acid). The fatty acid additive is miscible with the fatty acid nutritional supplement. Accordingly, the melt point of a mixture of the fatty acid nutritional supplement with the 80% oleic acid decreases toward the melt point of oleic acid (55° F. to 57° F.) as the oleic acid content increases. (FIG. 9, IV). In contrast, after an initial decrease in melt point as the HMTBa content is increased from 0% to 5%, the melt point of the exemplary animal feed composition remains relative constant—i.e., within ±1.5° F.—as the HMTBa content increases despite the melt point of HMTBa being much lower (approximately 85° F.) than the melt point of the mixture composition. Thus, once can readily increase the HMTBa content of the animal feed composition without significantly altering the melt point. This allows the animal feed composition to remain in a solid form and retain its handling properties even at temperatures above, for example, 100° F.

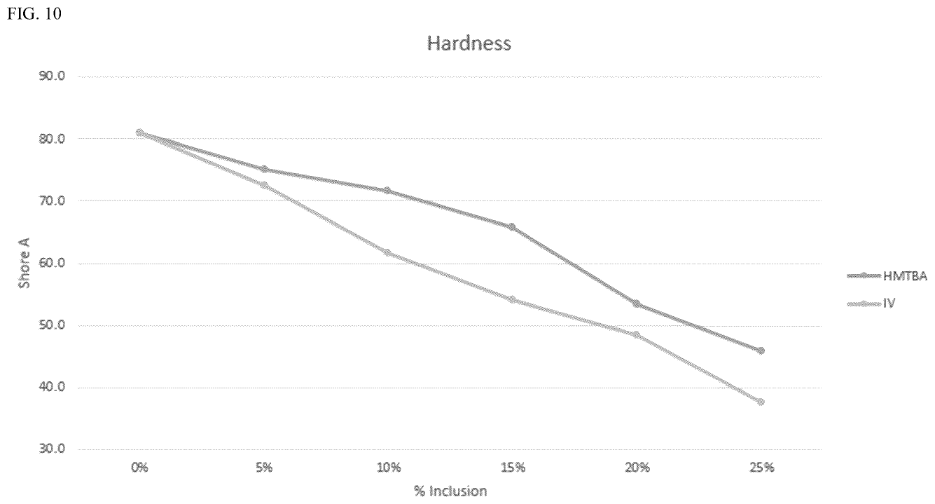

FIG. 10 shows Shore A hardness various compositions as a function of the HMTBa content relative to a comparable composition of a fatty acid nutritional supplement containing a fatty acid additive (e.g., 80% oleic acid).

In some embodiment, the animal feed composition can include a minimum of at least 1 wt % liquid nutrient such as, for example, at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 13 wt %, at least 14 wt %, at least 15 wt %, at least 16 wt %, at least 17 wt %, at least 18 wt %, at least 19 wt %, or at least 20 wt %.

In some embodiment, the animal feed composition can include a maximum of no more than 40 wt % liquid nutrient such as, for example, no more than 35 wt %, no more than 30 wt %, no more than 25 wt %, no more than 20 wt %, no more than 19 wt %, no more than 18 wt %, no more than 17 wt %, no more than 16 wt %, no more than 15 wt %, no more than 14 wt %, no more than 13 wt %, no more than 12 wt %, no more than 11 wt %, or no more than 10 wt %. A component is said to be present in amounts “no more than” a reference amount or concentration when the component is not absent but is present in an amount up to the reference amount or concentration.

In some embodiments, the animal feed composition can include an amount of liquid nutrient that falls within a range having endpoints defined by any minimum amount listed above and any maximum amount listed above that is greater than the selected minimum amount. For example, the animal feed composition can include liquid nutrient in an amount of from 1 wt % to 40 wt %, from 2 wt % to 20 wt %, from 5 wt % to 10 wt %, from 10 wt % to 35 wt%, from 5 wt% to 25 wt %, etc.

In certain embodiments, the animal feed composition can include an amount of liquid nutrient that is equal to any minimum amount or any maximum amount listed above. Thus, for example, the animal feed composition can include 1 wt % liquid nutrient, 3 wt % liquid nutrient, 5 wt % liquid nutrient, 7 wt % liquid nutrient, 8 wt % liquid nutrient, 10 wt % liquid nutrient, 15 wt % liquid nutrient, or 20 wt % liquid nutrient.

In some cases, an animal feed supplement as described herein can provide benefits compared to co-feeding a fatty acid-based nutritional supplement and the liquid nutrient. For example, having the liquid nutrient incorporated into the solid prill can provide a modified release (analogous to sustained release) of the liquid nutrient compared to co-feeding. Further, having the liquid nutrient incorporated into the solid prill increases the amount of the liquid nutrient that bypasses the rumen and reaches the lower gastrointestinal tract of the cow. Finally, having the liquid nutrient incorporated into the prill can improve digestion of the fat component. One or more of these benefits can result in a change in milk production by lactating dairy cows.

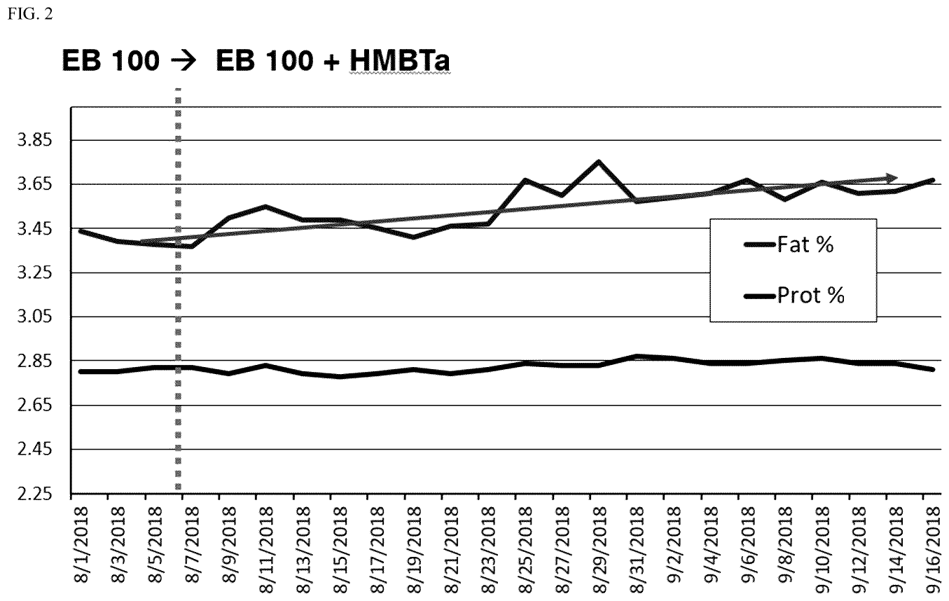

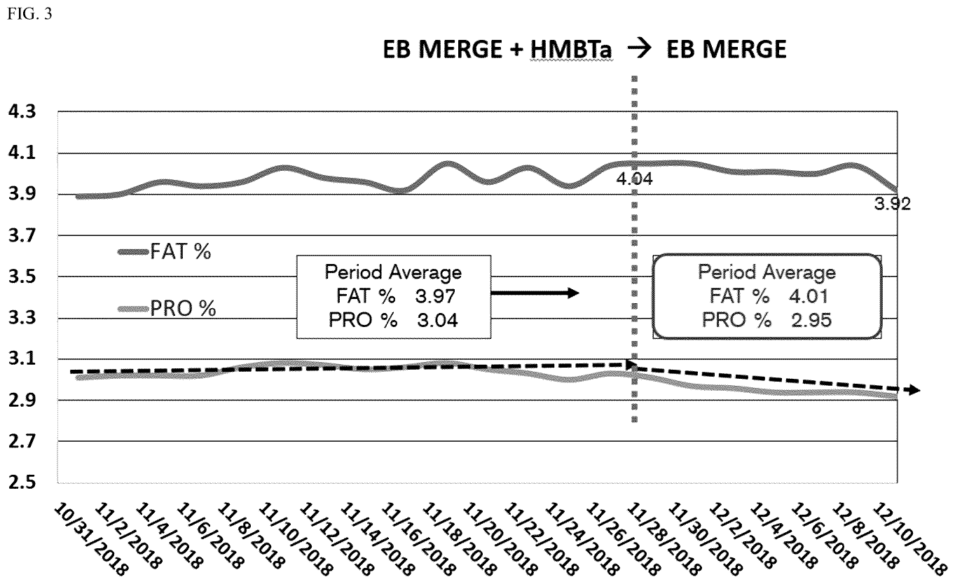

For example, adding HMTBa to a fatty acid-based animal feed can boost the milk fat content of milk produced by lactating dairy cows when the cows are producing milk with low fat content. As used herein, “low fat content” refers to milk produced by a lactating dairy cow having a fat content of no more than 3.5%. Adding HMTBa to a fatty acid-based animal feed increased the fat content of milk produced by lactating dairy cows, from about 3.37% milk fat to about 3.67% milk fat (FIG. 2), thereby increasing the fat content of the milk to a commercially desirable level. Removing HMTBa from the fatty acid-based animal feed decreased the protein content of milk produced by lactating dairy cows from about 3.05% to about 2.95% (FIG. 3).

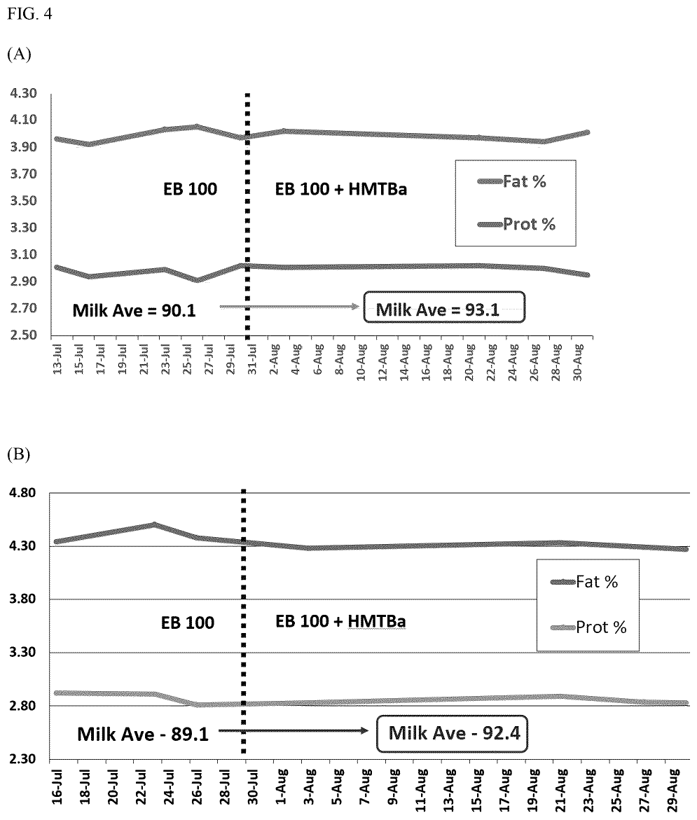

As another example, FIG. 4 provides data showing that adding HMTBa to a fatty acid-based animal feed can increase milk production, in one case increasing production by 3.0 pounds per day. (FIG. 4A). In another case, milk production increased by 3.3 pounds per day.

Thus, in another aspect, this disclosure describes methods of increasing milk production in a lactating cow, increasing milk fat content in milk produced by a lactating cow, and/or increasing milk protein content in milk produced by a lactating cow. Generally, the methods include feeding to the cow a nutritional supplement that includes any embodiment of the animal feed composition. The nutritional supplement can be provided in an amount and for a time effective to increase milk production of the cow, increase the fat content of milk produced by the cow, and/or increase the protein content of milk produced by the cow compared to the milk production, fat content of the milk produced by the cow, and/or protein content of the milk produced by the cow prior to being fed the animal feed composition.

Providing the animal feed composition to a lactating cow with lower than desired milk production can increase milk production by the cow. Providing the animal feed composition to a lactating cow producing milk with low fat content can increase the fat content of the milk produced by the cow. Providing the animal feed composition to a lactating cow producing milk with low protein content can increase the protein content of the milk produced by the cow.

In the preceding description and following claims, the term “and/or” means one or all of the listed elements or a combination of any two or more of the listed elements; the terms “comprises,” “comprising,” and variations thereof are to be construed as open ended—i.e., additional elements or steps are optional and may or may not be present; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

In the preceding description, particular embodiments may be described in isolation for clarity. Unless otherwise expressly specified that the features of a particular embodiment are incompatible with the features of another embodiment, certain embodiments can include a combination of compatible features described herein in connection with one or more embodiments.

For any method disclosed herein that includes discrete steps, the steps may be conducted in any feasible order. And, as appropriate, any combination of two or more steps may be conducted simultaneously.

The present invention is illustrated by the following examples. It is to be understood that the particular examples, materials, amounts, and procedures are to be interpreted broadly in accordance with the scope and spirit of the invention as set forth herein.

### EXAMPLES

### Materials

Animal fat and/or plant fat that is solid at room temp (70° F.). Exemplary suitable fats include mostly saturated free fatty acids including, but not limited to, myristic acid, palmitic acid, stearic acid, oleic acid, and blends of any of the foregoing.

Methionine analog: 2-hydroxy-4-(methylthio) butanoate (HMTBa). Typical composition is 88% methionine activity and 12% water (ALIMET, Novus International, St. Charles, MO).

Butyric acid (Eastman Chemical Co., Kingsport, TN)

Isobutyric acid (Eastman Chemical Co., Kingsport, TN)

Lecithin (Solae LLC, St. Louis, MO)

Lysolecithin K (Kemin, Des Moines, IA)

Lysolecithin TA (Thew Arnott & Co., Deeside, UK)

Propylene glycol (Aspen Veterinary Resources Ltd., Liberty, MO)

### Production Methods

Fat used is solid at room temperature and therefore made up of mostly saturated fatty acids. The fat is kept above its melting point of 125° F. in an insulated tank so that the fat is a liquid. Fat is then pumped over to a mix tank that is also kept above the fat's melting point.

The methionine analogue is then pumped into the mix tank with the liquid fat. The fat and methionine analog were mixed together with agitation, tank recirculation, or a combination of both.

The liquid is then pumped up to the top of a chilled prilling tower. The hot liquid is sprayed downwards at 90-100 psi and at 140° F. Chilled recirculating air (40° F.) is blown upwards towards the nozzle, goes out the top of the tower to a dust collector, into a fan that blows the air through a cooling coil and back into the bottom of the tower, making the prilling tower a closed loop system. The hot liquid being exposed to chilled air makes the droplets solidify and essentially prill. The solid powdered fat is collected at the bottom of the prilling tower through an airlock and conveyed to packaging.

### Characteristics of the Product are Shown in FIGS. 5-10.

Angle of repose was measured by mixing 500-gram batches of each composition in a kitchen mixer (Viking Range LLC, Greenwood, MS) for five minutes. After mixing, each batch was placed into a 1-liter beaker. The beaker was inverted onto a piece of office paper and removed slowly. The angle of repose was measured from the tabletop to the top of the pile of prills using a digital protractor.

The complete disclosure of all patents, patent applications, and publications, and electronically available material cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

1. An animal feed composition comprising:
a liquid nutrient component in an amount of 1% to 40% by weight;
a fatty acid component in an amount of 60% to 99% by weight; and
a melting point of at least 70° F.

2. The animal feed composition of claim 1, wherein the liquid nutrient component is present in an amount of from 1% to 25%.

3. The animal feed composition of claim 1, wherein the composition has a Shore A hardness of at least 50.

4. The animal feed composition of claim 1, wherein the liquid nutrient comprises a liquid analog of a solid nutrient.

5. The animal feed composition of claim 1, wherein the liquid nutrient comprises a liquid analog of methionine.

6. The animal feed composition of claim 1, further comprising tallow, lard, corn oil, soy oil, coconut oil, palm oil, palm stearin, a hydrogenated fat, a non-hydrogenated fat, an emulsifier, a fat-soluble vitamin, an organic acid, a cation, or any combination of two or more of the foregoing.

7. The animal feed product of claim 1, wherein the melting point is at least 120° F.

8. A method of making a solid animal feed supplement from liquid materials, the method comprising:
melting a fatty acid composition;
adding a liquid nutrient to form an intermediate mixture; and
cooling the intermediate mixture in a manner effective to produce a solid animal feed supplement.

9. The method of claim 8, wherein cooling the intermediate mixture comprises introducing the intermediate into a prilling tower.

10. The method of claim 8, wherein the solid animal feed supplement has a Shore A hardness of at least 50.

11. The method of claim 8, wherein adding the liquid nutrient forms an intermediate mixture having a fatty acid:liquid nutrient ratio of from 99:1 to 75:25, by weight.

12. The method of claim 8, wherein the liquid nutrient comprises an analog of methionine.

13. A method of increasing milk production in a lactating cow, the method comprising:
administering to the lactating cow a nutritional supplement comprising the animal feed composition of claim 1.

14. A method of increasing milk fat content in milk with low fat content produced by a lactating cow, the method comprising:
administering to the lactating cow a nutritional supplement comprising the animal feed composition of claim 1.

15. A method of increasing milk protein content in milk with low protein content produced by a lactating cow, the method comprising:
administering to the lactating cow a nutritional supplement comprising the animal feed composition of claim 1.
